(19) United States
(12) Patent Application Publication
(10) Pub. No.: US 2009/0138995 A1
(43) Pub. Date: May 28, 2009

(54) ATOM PROBE COMPONENT TREATMENTS

(76) Inventors: Thomas F. Kelly, Madison, WI (US); David J. Larson, Madison, WI (US); Richard L. Martens, Madison, WI (US); Keith J. Thompson, Fitchburg, WI (US); Robert M. Ulfig, Middleton, WI (US); Scott A. Wiener, Mount Horeb, WI (US)

Correspondence Address: PERKINS COIE LLP;PATENT-SEA, P.O. BOX 1247, SEATTLE, WA, 98111-1247, US

(21) Appl. No.: 11/917,672

(22) PCT Filed: Jun. 16, 2006
(86) PCT No.: PCT/US06/23532

§ 371 Date: Aug. 12, 2008

Related U.S. Application Data
(60) Provisional application No. 60/691,004, filed on Jun. 16, 2005.

(51) Int. Cl. G12B 21/00

(52) U.S. Cl. 850/60

(57) ABSTRACT

The present invention relates to treatments for atom probe components. For example, certain aspects are directed toward processes for treating an atom probe component that includes removing material from a surface of the atom probe component (e.g., using an ion beam, a plasma, a chemical etching process, and/or photonic energy). Another aspect of the invention is directed toward a method for treating an atom probe specimen that includes using a computing device to automatically control a voltage used in an ion sputtering process. Still other aspects of the invention are directed toward methods for treating an atom probe component that includes introducing photonic energy proximate to a surface of the atom probe component, annealing at least a portion of a surface of the atom probe component, coating at least a portion of a surface of the atom probe component, and/or cooling at least a portion of the atom probe component.

### CROSS-REFERENCE TO RELATED APPLICATION(S)

This application claims the benefit of U.S. Provisional Patent Application No. 60/691,004, filed Jun. 16, 2005, entitled ATOM PROBE COMPONENT TREATMENTS, which is fully incorporated herein by reference.

### TECHNICAL FIELD

Embodiments of the present invention relate to treatments for atom probe components, including treatments for atom probe components used in atom probe devices (e.g., atom probe microscopes).

### BACKGROUND

An atom probe (e.g., atom probe microscope) is a device which allows specimens to be analyzed on an atomic level. For example, a typical atom probe includes a specimen mount, an electrode, and a detector. During analysis, a specimen is carried by the specimen mount and a positive electrical charge (e.g., a baseline voltage) is applied to the specimen. The detector is spaced apart from the specimen and is negatively charged. The electrode is located between the specimen and the detector, and is either grounded or negatively charged. A positive electrical pulse (above the baseline voltage) and/or a laser pulse (e.g., photonic energy) is intermittently applied to the specimen. Alternately, a negative pulse can be applied to the electrode. With each pulse, one or more atom(s) on the specimen surface is ionized. The ionized atom(s) separate or “evaporate” from the surface, pass though an aperture in the electrode, and impact the surface of the detector. The identity of an ionized atom can be determined by measuring its time of flight between the surface of the specimen and the detector, which varies based on the mass/charge ratio of the ionized atom. The location of the ionized atom on the surface of the specimen can be determined by measuring the location of the atom's impact on the detector. Accordingly, as the specimen is evaporated, a three-dimensional map of the specimen's constituents can be constructed.

Specimens, electrodes, and other related components used in, or that are part of, the atom probe can be degraded or contaminated when various components are transferred from a preparation area (e.g., a focused ion beam (FIB) station or an electrical discharge machining (EDM) workstation) to the atom probe. For example, oxidation, corrosion, or other forms of contamination can occur during this transfer process, which in turn can influence ionization characteristics. In some cases, changes in ionization characteristics can decrease the likelihood of successful atom probe analysis (see e.g., M. K. Miller, Atom Probe Tomography (2000), which is fully incorporated herein by reference).

This problem can be exacerbated by the fact that specimens, electrodes, and related components can be prepared or assembled at one location and shipped great distances prior to being placed in an atom probe at another location. In addition, atom probe components can be stored at times in an uncontrolled environment at a given facility for long periods of time between preparation and use. Storage, shipping and handling typically occur in uncontrolled environments where these components can be contaminated or become oxidized. Oxidation and contamination of these components can degrade the performance of the atom probe. Even solvent and/or ultrasonic cleaning (standard ultra high vacuum (UHV) procedures) are often insufficient to clean these components after they have become contaminated or oxidized.

Historically some atom probe specimens have been heated to remove some contaminants from the surface of the specimens. However, in some cases, heating can degrade the atomic structure of the specimen, which in turn can affect the quality of analysis provided by the atom probe (see e.g., Miller). Ultraviolet lamps have also been used inside of atom probe chambers to desorb water vapor and other gasses (e.g. carbon dioxide) that have adsorbed onto the walls during venting of the instrument. Dry nitrogen purges have also been used to reduce the moisture or oxygen level in an atom probe chamber. In some cases, reaction chambers have been used to purposely oxidize or rapidly age specimens to simulate some real-world process in order to analyze materials that have been aged or used in service. Field-induced ion sputtering has also been used to sharpen atom probe specimens (see e.g., A. P. Janssen et al, The Sharpening of Field Emitter Tips by Ion Sputtering, J. Phys. D: Appl. Phys. 4, 118-123 (1971) and D. J. Larson et al., Sharpening and Positioning of Regions of Interest in Atom Probe Samples Using In-Situ Sputtering, Microscopy Microanal 9 (Suppl. 2) (2003), both of which are fully incorporated herein by reference). However, this process is labor intensive and somewhat problematic because the condition of the specimen must be manually monitored and the voltage used in the sputtering process must be manually adjusted. Accordingly, adjustments are often made too slowly or too inaccurately, potentially resulting in damage to the specimen. Accordingly, there is a need for additional atom probe component treatment processes.

### SUMMARY

The present invention is directed generally toward treatments for atom probe components. One aspect of the invention is directed toward a method for treating an atom probe component that includes providing an atom probe component having a surface. The method further includes removing material from the surface while the surface is positioned within at least a portion of an atom probe device or within a chamber that is attachable to an atom probe device.

Another aspect of the invention is directed toward a method for treating an atom probe specimen that includes providing an atom probe specimen. The method further includes sensing at least one parameter associated with a shape of the specimen. The method still further includes removing material from the surface of the specimen using an ion sputtering process and using a computing device to automatically control a voltage used in the ion sputtering process based on the at least one parameter.

Still another aspect of the invention is directed toward a method for treating an atom probe component that includes providing an atom probe component having a surface. The method further includes introducing photonic energy proximate to the surface of the atom probe component to at least one of (a) remove material from the surface, (b) make the surface smoother, and (c) alter the microstructure of the surface.

Yet another aspect of the invention is directed toward a method for treating an atom probe component that includes providing an atom probe component having a surface. The method further includes heating at least a portion of the surface to a high temperature. The method still further includes cooling a portion of the surface to anneal the at least a portion of the surface.

Still another aspect of the invention is directed toward a method for treating an atom probe component that includes providing an atom probe component having a surface. The method further includes coating at least a portion of the surface with a material to at least one of (a) increase an effective radius of a protrusion, (b) change the work function associated with the surface, and (c) protect the surface from contamination.

Yet another aspect of the invention includes a method for treating an atom probe component that includes positioning an atom probe component in an atom probe device. The method further includes cooling at least a portion of the atom probe component to at least one of (a) reduce a potential for field emissions, (b) reduce a potential for thermionic emission, and (c) reduce or slow a migration of contaminants within the atom probe device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a partially schematic illustration of an atom probe device that includes an atom probe assembly with an atom probe electrode in accordance with embodiments of the invention.

FIG. 2 is an isometric illustration of an atom probe carousel in accordance with certain embodiments of the invention.

FIG. 3 is a partially schematic top plan view of the atom probe carousel shown in FIG. 2.

FIG. 4 is a partially schematic illustration of an environmentally controlled container in accordance with certain embodiments of the invention.

FIG. 5 is a flow diagram illustrating an atom probe component treatment process in accordance with selected embodiments of the invention.

FIG. 6 is a partially schematic illustration of an atom probe component with contamination and protrusions in accordance with certain embodiments of the invention.

FIG. 7 is a partially schematic illustration of the atom probe component shown in FIG. 6 after material has been removed from a surface of the atom probe component in accordance with selected embodiments of the invention.

FIG. 8 is a flow diagram illustrating an atom probe component treatment process in accordance with other embodiments of the invention.

FIG. 9 is a flow diagram illustrating an atom probe component treatment process in accordance with still other embodiments of the invention.

FIG. 9A is a partially schematic illustration of an atom probe component with a coating in accordance with selected embodiments of the invention.

FIG. 10 is a flow diagram illustrating an atom probe component treatment process in accordance with yet other embodiments of the invention.

FIG. 11 is a flow diagram illustrating an atom probe component treatment process in accordance with still other embodiments of the invention.

FIG. 12 is a flow diagram illustrating an atom probe component treatment process in accordance with yet other embodiments of the invention.

### DETAILED DESCRIPTION

In the following description, numerous specific details are provided in order to give a thorough understanding of embodiments of the invention. One skilled in the relevant art will recognize, however, that the invention may be practiced without one or more of the specific details, or with other methods, components, materials, etc. In other instances, well known structures, materials, or operations are not shown or described in order to avoid obscuring aspects of the invention.

References throughout the specification to “one embodiment” or “an embodiment” means that a particular feature, structure, or characteristic described in connection with the embodiment is included in at least one embodiment of the present invention. Thus, the appearances of the phrase “in one embodiment” or “in an embodiment” in various places throughout the specification are not necessarily all referring to the same embodiment. Furthermore, the particular features, structures, or characteristics may be combined in any suitable manner in one or more embodiments.

Accordingly, various embodiments of the invention are described below. First, the structure and operation of atom probe devices are discussed. Then, various treatment processes in accordance with embodiments of the invention are described.

### A. Atom Probe Devices

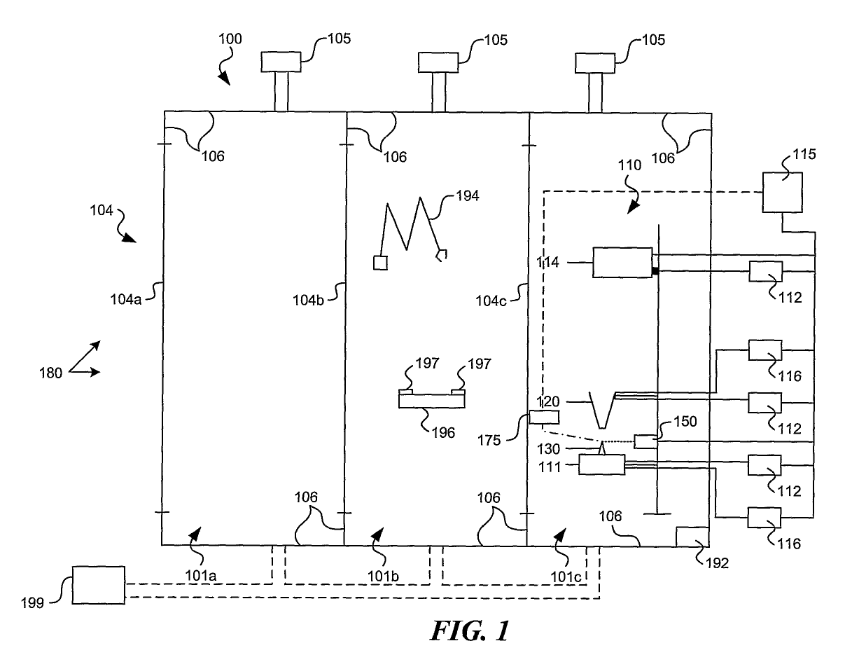

FIG. 1 is a partially schematic illustration of an atom probe device 100 in accordance with embodiments of the invention. In the illustrated embodiment, the atom probe device 100 includes a load lock chamber 101a, a buffer chamber 101b, and an analysis chamber 101c (shown collectively as chambers 101). The atom probe device 100 also includes a computer 115 and an atom probe assembly 110 having a specimen mount 111, an atom probe electrode 120, a detector 114, and an emitting device 150 (e.g., an emitting device configured to emit laser or photonic energy). The mount 111, electrode 120 and detector 114 can be operatively coupled to electrical sources 112. The electrode 120 and mount 111 can also be operatively coupled to temperature control devices 116 (e.g., cold/hot fingers that can provide contact cooling/heating to the atom probe electrode 120 and/or a specimen 130 carried by the mount 111). The emitting device 150, the detector 114, the voltage sources 112, and the temperature control devices 116 can be operatively coupled to the computer 115, which can control the analysis process, atom probe device operation, selected atom probe component treatment processes, and/or an image display.

In the illustrated embodiment, each chamber 101 is operatively coupled to a fluid control system 105 (e.g., a vacuum pump, turbo molecular pump, and/or an ion pump) that is capable of lowering the pressure in the chambers 101 individually. Additionally, the atom probe device 100 can include sealable passageways 104 (e.g., gate valves) positioned in the walls 106 of the chambers 101 that allow items to be placed in, removed from, and/or transferred between the chambers 101. In the illustrated embodiment, a first passageway 104a is positioned between the interior of the load lock chamber 101a and the exterior of the atom probe device 100, a second passageway 104b is positioned between the interior of the load lock chamber 101a and the interior of the buffer chamber 101b, and a third passageway 104c is positioned between the interior of the buffer chamber 101b and the interior of the analysis chamber 101c. In certain embodiments, a transfer device 194 (e.g., a mechanical arm) can be positioned to move items between the chambers 104 and/or place or remove items on/in the atom probe assembly 110.

In FIG. 1, a specimen can be placed in the load lock chamber 101a via the first passageway 104a. All of the passageways 104 can be sealed and the fluid control system 105 can lower the pressure in the load lock chamber 101a (e.g., reduce the pressure to 10⁻⁶-10⁻⁷ torr). The pressure in the buffer chamber 101b can be set at approximately the same or a lower pressure than the load lock chamber 101a. The second passageway 104b can be opened, the specimen 130 can be transferred to the buffer chamber 101b, and the second and third passageways 104b and 104c can be sealed.

The fluid control system 105 can then lower the pressure in the buffer chamber 101b (e.g., reduce the pressure to 10⁻⁸-10⁻⁹ torr). The pressure in the analysis chamber 101c can be set at approximately the same or a lower pressure than the buffer chamber 101b. The third passageway 104c can be opened, the specimen 130 can be transferred to the analysis chamber 101c, and the third passageway 104c can be sealed.

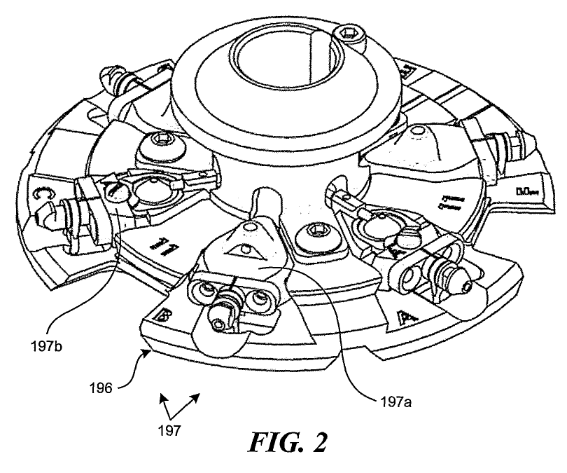

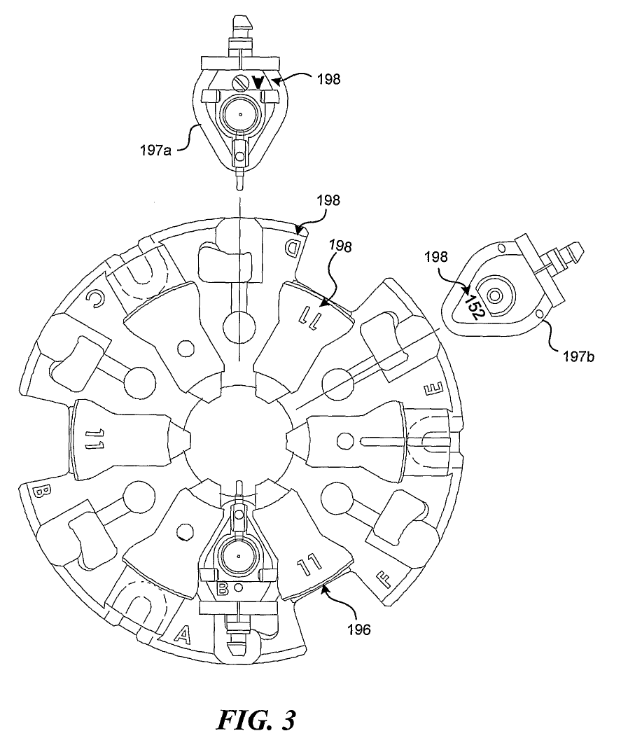

The fluid control system 105 can then reduce the pressure in the analysis chamber 101c (e.g., the pressure can be lowered to 10⁻¹⁰-10⁻¹¹ torr) prior to analysis of the specimen 130. In the illustrated embodiment, a getter 192 is positioned in the analysis chamber 101c to aid in lowering the pressure. In other embodiments, a getter 192 can be used in other chambers 101 or not used in the atom probe device. In still other embodiments, multiple items can be loaded or positioned in the chambers 101 of the atom probe device 100 using a similar method. For example, multiple specimens 130 and/or electrodes 120 can be positioned in the buffer chamber 101b on one or more carousels 196 (shown in further detail in FIGS. 2 and 3) and rotated through the analysis chamber 101c for analysis and/or use. In other embodiments, a first carousel can be used to carry specimens 130 and a second carousel can be used to carry electrodes 120.

In selected embodiments, the carousel 196 can include pucks or holders 197 that carry the specimens 130 and/or electrodes 120 on the carousel. The holders 197 can be removable from the carousel to facilitate movement and installation of individual specimens 130 and/or electrodes 120 in the atom probe assembly 110. In the illustrated embodiment, the carousel carries first holders 197a configured to hold electrodes 120 and second holders 197b configured to hold specimens. In selected embodiments, the carousel 196 and/or holders 197 can include labeling 198. The labeling 198 can be used to identify various portions of the carousel and holders so that various atom probe components can be identified and located by their position on a carousel. For example, the labeling 198 can be used to identify one carousel from another, various carousel, positions, and individual holders.

During analysis of the specimen 130, a positive electrical charge (e.g., a baseline voltage) can be applied to the specimen. The detector can be negatively charged and the electrode can be either grounded or negatively charged. A positive electrical pulse (above the baseline voltage) can be intermittently applied to the specimen 130 or a negative electrical pulse can be applied to the electrode 120. The electric field(s) created by the electrical charges can provide energy to ionize one or more atom(s) on the surface of the specimen 130. These ionized atom(s) can separate or “evaporate” from the surface, pass though an aperture in the electrode 120, and impact the surface of the detector 114. As the specimen 130 is evaporated, a three-dimensional map of the specimen's constituents can be constructed.

In certain embodiments, laser or photonic energy from the emitting device 150 can be used to thermally pulse a portion of the specimen 130 to assist with the evaporation process (e.g., the removal of ionized atoms). Additionally, in certain embodiments a temperature control device 116 can be used to cool the specimen 130 to reduce thermal motion and thermionic emission from the specimen. Thermionic emission includes the flow of one or more electrons from a metal or metal oxide surface, caused by thermal vibrational energy overcoming the electrostatic forces holding electrons to the surface. Thermionic emission from portions of the specimen 130 (or specimens in a multiple array) can reduce the accuracy of the analysis process.

In other embodiments, the atom probe device 100 can have more, fewer, and/or other arrangements of components. For example, in certain embodiments the atom probe device 100 can include more or fewer chambers, or no chambers. In selected embodiments, the atom probe device 100 can include one or more chambers dedicated for carrying out one or more of the atom probe component treatment processes discussed below.

In other embodiments, the atom probe device can include multiple atom probe electrodes 120 and/or electrode(s) 120 having different configurations/placements (e.g., planar electrode(s)). In still other embodiments, the atom probe device 100 includes more, fewer, or different emitting devices 150; more, fewer, or different temperature control systems 116; and/or more, fewer or different electrical sources 112. As used here in, atom probe components 180 can include any component associated with an atom probe device. For example, atom probe components 180 can include specimens, electrodes, the atom probe assembly, specimen holders, electrode holders, carousels, and other atom probe device components (e.g. chamber walls and gate valve surfaces).

### B. Treatment Processes

Selected embodiments of the invention include treatment processes for various atom probe components. For example, selected embodiments include processes for removing contaminates from various atom probe components. Other embodiments include treatment processes that prevent contamination. Still other embodiments include processes that improve the surface characteristics of various atom probe components. For example, various treatment processes can include ion milling, plasma cleaning/etching, chemical etching, annealing, coating, component cooling, laser or photonic energy application, and automated field induced ion sputtering.

In certain circumstances, some of these embodiments can improve the operation of the atom probe device and/or the analysis process. For example, some of the embodiments can improve viability in atom probe analysis by reducing field electron emission, gaseous vacuum discharge, and/or specimen fracture rate. Additionally, some treatments can improve the overall vacuum level and integrity in the atom probe device by liberating or oxidizing materials adsorbed on the interior of the atom probe chambers. Still other embodiments can decrease non-uniformities (e.g., distortions) in the electric field(s) used during analysis, which can interfere with the operation of the atom probe (e.g., non-uniformities in the electric field(s) can cause interfere with the orderly evaporation of the specimen and/or cause electrode or specimen field emission).

Many or all of the embodiments discussed below can be performed in the atom probe device (e.g., in the load lock chamber, buffer chamber, and/or the analysis chamber). Some of the embodiments discussed below can be performed in a minimally controlled environment (e.g., at room temperatures and ambient pressure) or in clean rooms having controlled environments where various environmental characteristics (e.g., temperature, pressure, and the composition of the surrounding fluid) can be selected and/or controlled. Accordingly, certain process portions can be accomplished under selected environmental conditions (e.g., in a high or low temperature environment and/or in a high or low pressure environment). The atom probe component(s) can then be transferred to the atom probe device (e.g., via a controlled environment chamber). Additionally, many or all of the processes can be performed in an environmentally controlled container or chamber that is couplable to the atom probed device, allowing the atom probe component to be transferred to the atom probe device while remaining in a controlled environment.

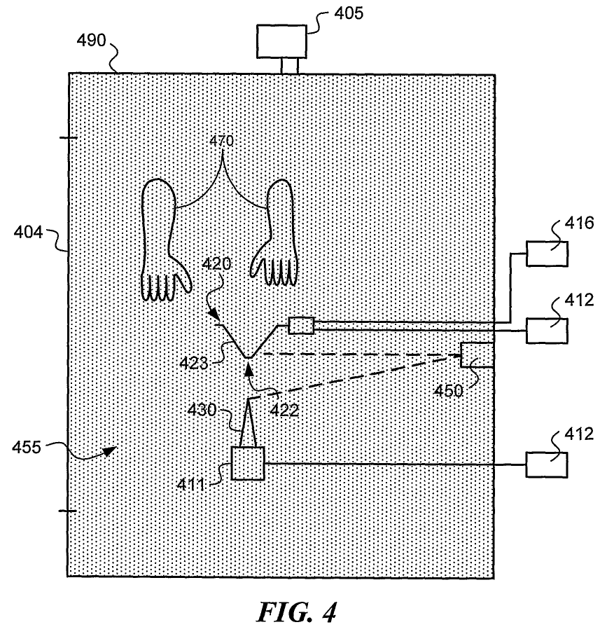

FIG. 4 is a partially schematic illustration of an environmentally controlled chamber or container 490 suitable for treating atom probe components. In the illustrated embodiment, the container 490 includes a glove box having integral gloves 470, a fluid control device 405, an emitting device 450, and a sealable passageway 404. The fluid control device 405 (e.g., an ion pump, a vacuum pump, a turbo molecular pump, and/or a fluid distribution system) controls the pressure in the container 490 and can introduce various fluids 455 (e.g., liquids or gases, including vapors or plasmas) into the container. The emitting device 450 can include various types of devices including an emitting device 450 that is configured to emit laser or photonic energy, radio frequency energy, an electron beam, a molecular beam, and/or an ion beam. The sealable passageway 404 opens to allow items to be placed in and removed from the container 490 and closes or seals to maintain the environmental conditions. In the illustrated embodiment, the passageway 404 is also configured to sealably couple to the first passageway 104a of the atom probe device 100, shown in FIG. 1. Accordingly, the container 490 can be coupled to the atom probe device 100 and items (e.g., atom probe components) can be transferred while remaining in a controlled environment.

In the illustrated embodiment, an atom probe electrode 420 is positioned in the container 490 and coupled to an energy source 412 (e.g., electrical source) and a thermal control device 416. In FIG. 4, the container 490 also includes a specimen mount 411 coupled to an energy source 412 (e.g., electrical source). In the illustrated embodiment, a specimen 430 is carried by the specimen mount 411. In other embodiments, the container 490 can include more, fewer, and/or other arrangements of components.

For example in certain embodiments, the container 490 does not include a specimen mount 411 and/or an emitting device 450. In other embodiments, a getter is used to control (e.g., lower) the pressure in the container 490 instead of the fluid control system 405. In still other embodiments, the thermal control device 416 has other arrangements. For example, the thermal control device 416 can be configured to cool or heat other atom probe components, a fluid in the container 490, and/or the entire container. In yet other embodiments, the atom probe component is treated in an environmentally controlled or uncontrolled lab and an environmentally controlled container 490 (e.g., a nitrogen dry box) is used to store the atom probe component and/or transport the atom probe component to an atom probe device.

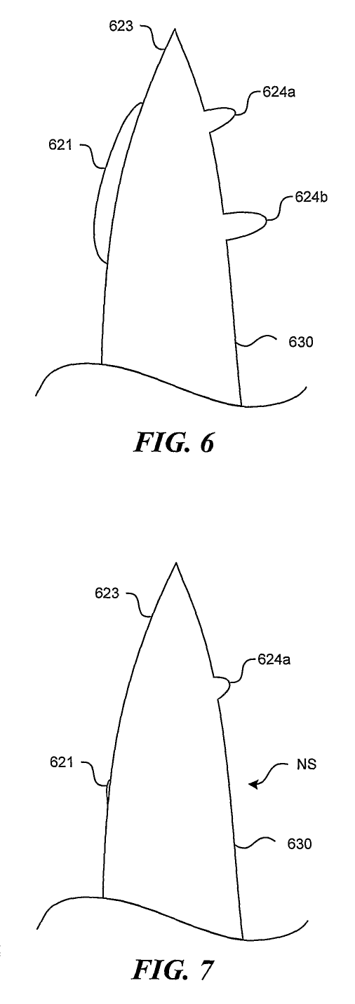

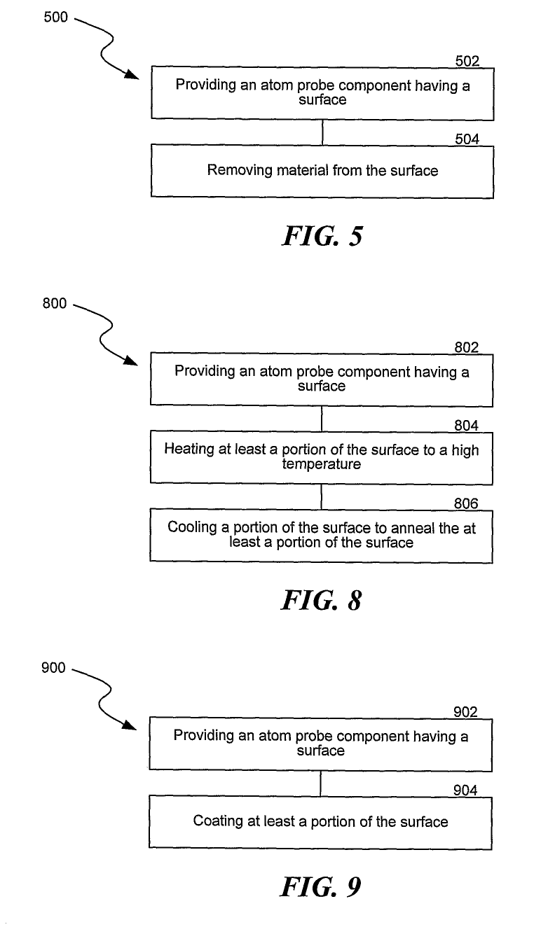

FIG. 5 is a flow diagram illustrating a process 500 for treating atom probe components in accordance with certain embodiments of the invention. The process in FIG. 5 includes providing an atom probe component having a surface (block 502) and removing material from the surface of the atom probe component (block 504). In selected embodiments, material can be removed from the surface of the atom probe component while the surface is positioned within at least a portion of an atom probe device or within a chamber that is attachable to an atom probe device (e.g., the environmentally controlled container 490 shown in FIG. 4) so that the surface remains in a controlled environment after material removal. In other embodiments, material can be removed from the surface of the atom probe component away from the atom probe device (e.g., in a lab or office) and transported to the atom probe device.

In certain embodiments, removing the material from the surface of the atom probe component can include removing at least a portion of a contaminant carried on the atom probe component. For example, a contaminant can include any unwanted material on or integral with the surface of the atom probe component, including oxidations, oxides, nitrides, solvents, oil, passive layers, hydrocarbons, other environmental contaminants, and the like. In other embodiments, the surface can include an original surface and removing material from the surface of the atom probe component can include removing at least a portion of the original surface to form a new surface, so that (a) the new surface has fewer protrusions than the original surface, (b) an effective radius of one or more protrusions on the new surface is increased over the one or more protrusions on the original surface, or (c) both (a) and (b).

For example, FIG. 6 is a partially schematic illustration of an atom probe component (e.g., a specimen 630) that has a surface 623 with a contaminant 621, a first protrusion 624a and a second protrusion 624b. FIG. 7 is a partially schematic illustration of the specimen 630, shown in FIG. 6, after material has been removed from the surface 623 of the specimen 630. In FIG. 7 at least a portion of the contaminant 621 has been removed. Additionally, material has been removed from the first protrusion, increasing the effective radius of the protrusion. Herein increasing the effective radius refers to changing the shape and curvature of a protrusion to reduce electric field concentrations (e.g., non-uniformities) that can be created by unwanted protrusions. Furthermore, the second protrusion has been removed, forming a new surface NS (e.g., a smoother surface than in FIG. 6) and reshaping the specimen 630. In other embodiments, material removal can reshape the atom probe component more drastically. For example, in selected embodiments material removal can be used to sharpen the tip of a specimen.

In selected embodiments, material can be removed from the surface of the atom probe component using an ion milling process. In other embodiments, material can be removed from the surface of the atom probe component using a plasma or plasma based process. In still other embodiments, material can be removed from the surface of the atom probe component using a chemical etching process. In yet other embodiments, material can be removed from the surface of the atom probe component using a laser or photonic energy emitter (e.g., to remove a layer of material from the surface of the atom probe device).

For example, in certain embodiments an ion beam milling process can be used to remove material from a surface of an atom probe component. The process can include impacting material on the surface of the atom probe and removing material from the surface using the ion beam. In a selected embodiment, the process can be performed in the container 490, shown in FIG. 4. For example, the emitting device 450 can be used to emit a focused or broad ion beam to remove material from an atom probe component. In certain embodiments, a broad ion beam can be particularly well suited for removing contaminants and a focused ion beam can be particularly well suited for removing or reshaping protrusions. In other embodiments, the ion beam milling process can be accomplished in an atom probe device (e.g., in the load lock or buffer chamber). When this process is accomplished in an atom probe device, the corresponding fluid control system can include a turbo molecular pump or an ion pump to evacuate ions from the chamber where the process is performed.

In certain embodiments, ion milling treatments can be particularly useful for removing contaminants, surface oxides, or surface nitrides. Additionally, in selected embodiments ion milling can extend the useful life of an atom probe electrode or result in better data quality (due to reduced noise). In still other embodiments, use of ion milling can enable analysis of materials that could not previously be analyzed in an atom probe due to fast forming passivation layers. In selected embodiments, a masking material (e.g., a photoresist material) or physical barrier can be used to block or occlude the ion beam from impacting certain portions of the atom probe component and/or selected atom probe components that are positioned in a chamber where an ion milling process is being used. This feature can allow selective milling of desired areas or components.

In other embodiments, a plasma or plasma process can also be used to remove material from an atom probe component. For example, the process can include introducing a plasma proximate to a surface of an atom probe component and removing material from the surface of the atom probe component using the plasma. For example, in selected embodiments the plasma process can be carried out in the container 490, shown in FIG. 4. For example, the fluid 455 can include a plasma generated by exposing a gas (e.g., oxygen, carbon tetrafluoride, or argon) to an electrical current (e.g., a direct current) or radio frequency energy (e.g., via the emitting device 450). The plasma can be used to clean contaminants from one or more atom probe component(s), including the interior of the entire chamber/container 490. In other embodiments the plasma can be used to etch protrusions from an atom probe component and/or used to increase an effective radius of a protrusion.

In still other embodiments plasma processes can be accomplished in an atom probe device (e.g., in the load lock or buffer chamber). For example, as shown in FIG. 1, a plasma generator 199 can be operatively coupled to one or more chambers of the atom probe device. The plasma produced in the plasma generator 199, can be introduced into the appropriate chamber(s), and can then be removed via the fluid control device(s) 105. In other embodiments, the plasma can be generated within the atom probe device in a manner similar to that described above with reference to the container 490.

In selected embodiments, plasma can be generated from oxygen, nitrogen, argon, nitrogen triflouride, and/or the like. In certain embodiments, plasmas can be used that are particularly well suited to react with certain types of materials. For example, in selected embodiments a plasma can be used that is particularly well suited for removing specific contaminants. In some embodiments, a plasma process can be carried out at high or low temperatures or pressures. For example, in certain embodiments when using a plasma generated from nitrogen triflouride, with or without argon, elevated temperatures can expedite material removal.

In yet other embodiments, a chemical process or chemical etching process can be used to remove material from a surface of an atom probe component. For example, the process can include introducing a chemical agent proximate to the surface of the atom probe component and removing material from the surface of the atom probe component using the chemical agent. Various chemical-based material removal methods (including both wet chemistry and vapor etch) can be used to remove material from an atom probe components. For example, sulfur hexafluoride (SF₆) can etch away portions of protrusions on a silicon surface of an atom probe component when the surface is maintained in an environment with a pressure of 0.6-2 mbar.

In selected embodiments, a chemical etching process can be carried out in the container 490 shown in FIG. 4. The fluid 455 can include a chemical bath or a chemical vapor and can be used to remove material from an atom probe component (e.g., a specimen). In certain embodiments, an electrical (e.g., DC) or radio-frequency bias can be applied to the component (e.g., applied to the specimen via the energy source 412 and/or the emitting device 450) while the material on the surface of the component is in contact with a chemical agent. In other embodiments, the chemical etching process can be carried out in portions of an atom probe device (e.g., in the load lock or buffer chambers).

In still other embodiments, laser or photonic energy can be used to remove material from a surface of an atom probe component. For example, in selected embodiments the emitting device 450 in the container 490, shown in FIG. 4 can be used to introduce laser or photonic energy proximate to the surface of the atom probe component. The laser or photonic energy can remove (e.g., burn off) material from the surface of the atom probe component. In other embodiments, the process can be carried out in various portions of an atom probe device.

As shown in FIG. 8, an annealing process 800 can also be used to treat an atom probe component. In selected embodiments, annealing process 800 can include providing an atom probe component having a surface (block 802), heating at least a portion of the surface to a high temperature (block 804), and cooling a portion of the surface to anneal the at least a portion of the surface (block 806). In certain embodiments, an annealing process can be carried out in the container 490, shown in FIG. 4. For example, in one embodiment the temperature control device 416 can be used to heat the surface of an atom probe component (e.g., a specimen) above approximately two-thirds of the melting point of a material of the surface. The surface can then be allowed to slowly cool. In other embodiments, the process can be carried out in a portion of an atom probe device (e.g., in the load lock or buffer chamber).

In selected embodiments, the annealing process can cause changes in the microstructure of the material. In certain embodiments the strength and hardness of the surface can be altered, as well as the crystalline structure and electronic properties. For example, the grain size of the material on the surface of an atom probe component can be increased when a surface is heated close to the melting point for a prolonged period of time. In selected embodiments, a larger grain size can reduces a materials susceptibility to absorb water vapor, thereby reducing outgassing in an atom probe analysis chamber. Additionally, in some embodiments a larger grain size can raise the overall field emission threshold of the material, thereby reducing the emission rate of electrons from the material and/or improving the electric field homogeneity. Because it is suspected that electron emission from components within the chamber located proximate to (e.g., within a few hundred microns on a specimen can create spurious emission of atoms from the specimen, an annealing process might be used on these components to reduce these spurious emissions. By reducing these emissions it is expected that the overall noise can be reduced during the analysis process.

In still other embodiments, the annealing process may be useful in preventing certain components form oxidizing, forming other contaminant layers, and/or picking up contaminants. Because the annealing process can alter the microstructure of an atom probe component surface, in selected embodiments annealing the surface may reduce the tendency for the surface to react with certain contaminants or with the environment. Accordingly, in certain embodiments the annealing process might be used on atom probe components that are going to be shipped or stored in an uncontrolled environment.

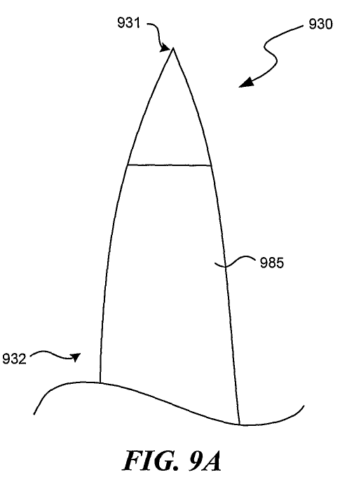

As illustrated in FIG. 9 a coating process 900 can be used to treat atom probe components. For example, the coating process 900 can include providing an atom probe component having a surface (block 902) and coating at least a portion of the surface (block 904). For instance, in certain embodiments the surface can be coated with a material to at least one of (a) increase an effective radius of a protrusion, (b) change the work function associated with the surface, and (c) protect the surface from contamination.

For example, in selected embodiments thick film deposition techniques including, but not limited to, electroplating can be used to apply a coating to an atom probe component. In one embodiment the container 490, shown in FIG. 4 can be used to carry out the coating process. The atom probe component (e.g., a specimen) can be immersed in one or more chemical baths (e.g., fluid 455) that add material with a negative DC or AC voltage applied to the atom probe component specimen via an energy source 412. Through this process, material can be added at protrusions as a result of the corresponding concentration in electric field. This addition of material can increase the effective radius of the protrusion making it less likely to cause electron emission during atom probe analysis. For example, in one embodiment a solution of 20-70% sulphuric acid and copper sulphate solution in water can be used to electroplate copper onto an atom probe components made from a variety of materials when a positive voltage (e.g., 1-20 Vdc) is applied to the atom probe component.

In other embodiments, a coating having a high work function material (e.g., platinum or tungsten) can be used. Materials with a high work function include materials which require larger amounts of energy to liberate electrons from their surfaces as compared to materials having low work functions. By adding material having a high work function through a coating process, the effective work function of the component being coated can be increased, thereby reducing electron emission from the surface during atom probe analysis. In embodiments where high work function material is used to coat a specimen, the high work function material can be removed from the tip of the specimen for analysis while the high work function coating is retained on other portions of the specimen.

In other embodiments, it can be desirable to coat an atom probe component with a low work function material. For example, in some embodiments the deposition of a low work function material may inhibit oxidation or corrosion on a component (e.g., on the apex of a specimen). Because the low work function material is more easily field evaporated, the material can be readily removed during the atom probe analysis process.

In other embodiments, thin film coating techniques can be used. These techniques can include Vapor or plasma deposition, chemical vapor deposition, physical vapor deposition, electron beam deposition, molecular beam epitaxy (MBE) and/or the like. Many of these processes can be used with or without an electrical bias or field being applied to the atom probe component and can be accomplished in the container 490, shown in FIG. 4. For example, in selected embodiments the fluid 455 can include a vapor or a plasma and an electrical bias or field can be created using an energy source 412. In other embodiments, the emitter 450 can be configured to produce an electron beam, molecular beam, and/or radio-frequency energy. In other embodiments, many or all of the coating techniques discussed above (e.g., thick and thin coating techniques) can be performed in portions of an atom probe device. FIG. 9A is a partially schematic illustration of an atom probe component (e.g., a specimen 930) where a coating 985 has been applied to a base portion 932 of the specimen 930 and not to an apex or tip portion 931. In the illustrated embodiment, the coating includes a metallic material. In other embodiments, the coating can include other materials (e.g., non-metallic materials).

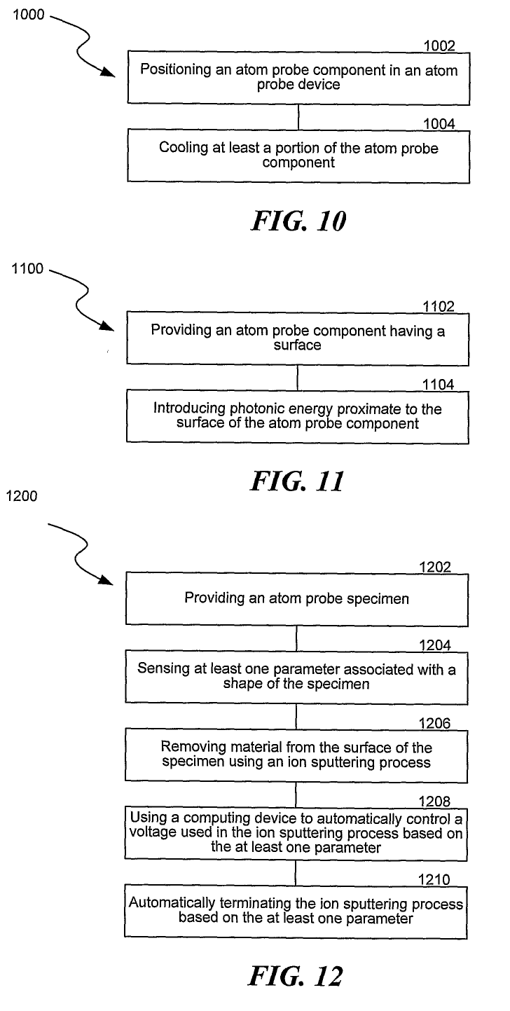

As illustrated in FIG. 10, atom probe components can also be treated by a cooling process 1000. For example, the cooling process 1000 can include positioning an atom probe component in an atom probe device (block 1002) and cooling at least a portion of the atom probe component (block 1004). For instance, in selected embodiments the at least a portion of the atom probe component can be cooled to at least one of (a) reduce a potential for field emissions, (b) reduce a potential for thermionic emission, and (c) reduce or slow a migration of contaminants within the atom probe device. For example, in certain embodiments the temperature control device 116 coupled to the specimen 130, shown in FIG. 1, can cool the surface of the specimen 130 to between 5-100 Kelvin, thereby reducing the thermal motion at the atomic level in the surface of the specimen 130 (e.g., the specimen can be cooled after the atom probe components have been effectively outgassed). Additionally, cooling the surface can also reduce the potential for field emission. The reduction in thermionic emission and/or the reduction in field emission can increase the accuracy of the analysis process. In other embodiments, cooling the electrode 120 can reduce or slow the migration of contaminants within the atom probe device, which can be caused by the electric field used for analysis.

In selected embodiments, after the specimen has been cooled the specimen can be analyzed via the atom probe analysis process. In selected embodiments, cooling can continue during the analysis process. For example, in one embodiment, a first portion (e.g., the base) of the specimen can be cooled and laser or photonic energy can be applied to a second portion (e.g., the tip or apex) of the specimen to aid in evaporation. In selected embodiments, this feature can reduce field emissions from the base of the specimen during the analysis process. Although, for illustrative purposes the cooling process was discussed with reference to a specimen, the cooling process can be used on other atom probe components (e.g., electrodes, mounts, and/or the like).

As illustrated in FIG. 11, laser or photonic energy can also be used to treat atom probe components. The process 1100 of using photonic energy to treat atom probe components can include providing an atom probe component having a surface (block 1102) and introducing laser or photonic energy proximate to the surface of the atom probe component (block 1104). For instance, laser or photonic energy can be introduced proximate to the surface of the atom probe component to at least one of (a) remove material from the surface, (b) make the surface smoother, and (c) alter the microstructure of the surface (e.g., atomic/molecular/crystalline structure). For example, in selected embodiments a photonic treatment process can be carried out in the container 490, shown in FIG. 4.

For example, in FIG. 4 the emitting device 450 can be configured to emit laser or photonic energy. In one embodiment, the photonic energy can be applied to a portion of the surface of an atom probe component to reduce disparities, inconsistency non-uniformities, and/or protrusions in a material of the surface (e.g., peening the portion of the surface to alter the microstructure of the surface material on or near the portion of the surface). In selected processes, the peening process can make the surface smoother and/or stronger. In other embodiments, the peening process can reduce field emissions associated with the peened surface. In yet other embodiments, altering the microstructure of the surface material can affect the work function associated with the surface and/or the molecular/crystalline consistency of the material in the surface.

In still other embodiments, photonic energy can be applied to the surface of the atom probe component to heat the surface (e.g., to anneal the surface similar to the annealing process discussed above). In yet other embodiments, laser or photonic energy can be applied to the surface to melt the surface. As the surface cools a smoother surface can be formed, thereby reducing protrusions and/or the potential for field emissions. In selected embodiments, annealing and/or melting the surface can alter the atomic structure of the surface and/or affect the work function associated with the surface. Additionally, as discussed above, photonic energy can also be used to remove material from the surface of the atom probe component. In still other embodiments, the process of applying photonic energy can be carried out on a portion of an atom probe device (e.g., in the load lock, buffer chamber, and/or analysis chamber).

In selected embodiments, coatings can be used in conjunction with photonic energy to obtain a desired effect. For example, in certain embodiments a coating configured to absorb photonic energy can be used to enhance the effectiveness of the photonic energy. For instance, specimens made from certain materials have poor emissivity do not absorb photonic energy effectively. By applying a thin coating that absorbs laser or photonic energy efficiently (e.g., gold or silicon oxy-nitride), the specimen may be thermally pulsed via the photonic energy during the analysis process.

In other embodiments, a coating configured to reflect photonic energy can be used to control the absorption of photonic energy into an atom probe component. For example, a reflective coating can be applied to a specimen below the apex or tip. As the tip of the specimen is exposed to photonic energy, the photonic energy can almost exclusively be absorbed in the tip of the specimen (e.g., at least a portion of the photonic energy can be reflected away from the coated portion of the specimen). The result can be a very controlled absorption of the laser or photonic energy in the tip region, and therefore a very controlled heating of the region of interest. In selected embodiments, this can result in better mass resolution and lower noise during analysis.

FIG. 12 illustrates an automated field induce ion sputtering process for treating atom probe components. The treatment process 1200 in FIG. 12 can include providing an atom probe specimen (block 1202) and sensing at least one parameter associated with a shape of the specimen (e.g., a tip radius of the specimen, a tip position of the specimen, and/or a field ion image quality) (block 1204). The process can further include removing material from the surface of the specimen using an ion sputtering process (block 1206) and using a computing device to automatically control a voltage used in the ion sputtering process based on the at least one parameter (block 1208). In further embodiments, the process can also include automatically terminating the ion sputtering process based on the at least one parameter (block 1210).

As described in Sharpening and Positioning of Regions of Interest in Atom Probe Samples using In-Situ Sputtering, an ion sputtering process is accomplished by applying a negative potential to a field ion sample to induce field emission in the presence of neon gas atoms at a reduced pressure in a chamber of an atom probe device (e.g., in the analysis chamber in which neon gas has been introduced via a fluid control device). Emitted electrons ionize the neon gas atoms and the electric field from the sample accelerates the ions back to the sample, from which they remove material by ion sputtering. This process may be used not only to sharpen samples, but also to position the specimen apex at the region of interest.

Currently, this process is accomplished manually. For example, an operator manually selects a voltage and observes the sputtering process (e.g., by using a scanning electron microscope to examine the specimen and/or observing a field ion image quality). The operator then adjusts the negative potential (e.g., the sputtering current) by some amount and observes the sputtering process. This process is labor intensive and results in significant time delays between sputtering current adjustments.

In selected embodiments of the invention, the computer 115 (shown in FIG. 1) or another computing device can be used to monitor and control the sputtering process in a computing environment. For example, the computer 115 can be operatively coupled to one or more sensors 175 (e.g., a scanning electron microscope or other scanning device) adapted to sense at least one parameter associated with a shape of the specimen 130. Additionally or alternately, in certain embodiments the computer 115 can be coupled to the detector 114, which can also provide one or more parameter associated with the shape of the specimen. The sensors 175 and/or detector 114 can send the associated parameter(s) to the computer 115. Upon receiving the associated parameters, the computer 115 can compute a desired sputtering current. The computer 115 can then send a command to the energy or electrical source 112 that is coupled to the specimen 130 to set the sputtering current to the desired value.

For example, in one embodiment an operator can select a desired amount of material to be removed from the specimen. For instance, in certain embodiments the operator can select a desired sharpness of the specimen tip, a desired shape of the specimen, the amount of material to be removed (e.g., to remove a contaminant, to create a new surface with fewer protrusions, to create a new surface with a protrusion having an increased effective radius, and/or the like). Based on the desired amount of material to be removed, the computer 115 can command the sensor 175 to sense a parameter associated with the shape of the specimen 130. The sensor can sense the parameter and send data corresponding to the parameter to the computer 115. The computer can compute a desired sputtering current and send a command to the electrical source 112 to provide the desired amount of current to the specimen.

Based on changes and/or the rate of changes in the parameter (or lack thereof) the computer can adjust the sputtering current via the same process. Once the parameter indicates that the desired sharpness of the specimen tip, a desired shape of the specimen, and/or the desired amount of material removal has been achieved, the computer can automatically terminate the sputtering process (e.g., set the sputtering current to zero). In selected embodiments, this automated sputtering process can be much less labor intensive and the sputtering current can be adjusted in a more timely manner as compared to the manual process.

In other embodiments, the automated sputtering process can be carried out in other chambers of the atom probe device or in a chamber similar to the container 490, shown in FIG. 4. Although in the above discussion, the computer 115 used to run atom probe analysis was used to carry out the automated sputtering process, in other embodiments other computing devices can be used, including distributed computing systems (e.g., multiple computing devices or elements operatively coupled together). Additionally, in selected embodiments instructions for a computer implemented method for an automated sputtering process can be stored on a computer readable medium.

In selected embodiments, many or all of the treatment strategies or processes discussed above can be automated (e.g., as computer implemented processes) and stored in a database or other computer readable medium. Accordingly, individual processes can be recalled and used at the appropriate time. For example, in one embodiment atom probe chambers that have been exposed to the atmosphere, say during service, may undergo a more rigorous cleaning regimen than atom probe chambers that are being cleaned or treated after use. In other embodiments, certain specimens, electrodes or carousels may require specific and/or different cleaning treatments or treatment intervals. Accordingly, the labeling 198 (shown in FIG. 3) can be used to identify various carousels and various portions of the carousel and holders so that various atom probe components (including the carousels) can be identified, located, and receive the appropriate treatment(s).

From the foregoing, it will be appreciated that specific embodiments of the invention have been described herein for purposes of illustration, but that various modifications may be made without deviating from the invention. Additionally, aspects of the invention described in the context of particular embodiments may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

I/We claim:

1. A method for treating an atom probe component, comprising:
providing an atom probe component having a surface;
introducing a plasma proximate to the surface of the atom probe component; and
removing material from the surface of the atom probe component using the plasma.

2. The method of claim 1 wherein removing material includes removing at least a portion of a contaminant carried on the atom probe component.

3. The method of claim 1 wherein the surface includes the original surface and removing material includes removing at least a portion of the original surface to form a new surface, so that (a) the new surface has fewer protrusions than the original surface, (b) an effective radius of one or more protrusions on the new surface is increased over the one or more protrusions on the original surface, or (c) a and b.

4. The method of claim 1 wherein an atom probe component includes electrodes, electrode holders, specimens, specimen holders, component carousels, and internal surfaces of an atom probe device.

5. The method of claim 1 wherein introducing a plasma includes introducing a plasma produced from at least one of oxygen, nitrogen, argon, and nitrogen triflouride.

6. The method of claim 1, further comprising producing the plasma using at least one of a direct current and radio frequency energy.

7. The method of claim 1, further comprising producing the plasma in a portion of an atom probe device.

8. The method of claim 1, further comprising producing the plasma in a plasma generation device that is couplable to an atom probe device.

9. The method of claim 1 wherein removing material includes removing material while the surface is located in a portion of an atom probe device.

10. The method of claim 1 wherein removing material includes removing material while the surface is positioned in a chamber that is couplable to a portion of an atom probe device.

11. A method for treating an atom probe component, comprising:
providing an atom probe component having a surface;
introducing a chemical agent proximate to the surface of the atom probe component; and
removing material from the surface of the atom probe component using the chemical agent.

12. The method of claim 11 wherein removing material includes removing at least a portion of a contaminant carried on the atom probe component.

13. The method of claim 11 wherein the surface includes the original surface and removing material includes removing at least a portion of the original surface to form a new surface, so that (a) the new surface has fewer protrusions than the original surface, (b) an effective radius of one or more protrusions on the new surface is increased over the one or more protrusions on the original surface, or (c) a and b.

14. The method of claim 11 wherein the atom probe component includes a specimen and introducing a chemical agent includes introducing a chemical agent proximate to the specimen with at least one of a direct current and radio frequency energy bias on the specimen.

15. The method of claim 11 wherein introducing a chemical agent includes introducing sulfur hexafluoride.

16. The method of claim 11, further comprising maintaining the surface in an environment with a pressure of 0.6-2 mbar.

17. The method of claim 11 wherein removing material includes removing material from the surface while the surface is positioned in a portion of an atom probe device.

18. The method of claim 11 wherein removing material from the surface includes removing material from the surface while the surface is positioned in a chamber that is couplable to a portion of an atom probe device.

19. A method for treating an atom probe component, comprising:
providing an atom probe component having a surface, the surface carrying a contaminant;
impacting the contaminant with an ion beam; and
removing at least a portion of the contaminant from the surface using the ion beam.

20. The method of claim 19 wherein impacting the contaminant includes impacting the contaminant with at least one of a broad ion beam and a focused ion beam.

21. The method of claim 19 wherein removing at least a portion of the contaminant includes removing at least a portion of the contaminant while the surface is positioned in a portion of an atom probe device.

22. The method of claim 19 wherein removing at least a portion of the contaminant includes removing at least a portion of the contaminant while the surface is positioned in a chamber that is couplable to a portion of an atom probe device.

23. The method of claim 19 wherein the method further comprises masking a portion of the atom probe component prior to impacting the contaminant to occlude the portion of the atom probe component from the ion beam.

24. A method for treating an atom probe component, comprising:
providing an atom probe component having a surface; and
removing material from the surface while the surface is positioned within at least a portion of an atom probe device or within a chamber that is attachable to an atom probe device.

25. The method of claim 24 wherein removing material includes removing at least a portion of a contaminant carried on the atom probe component.

26. The method of claim 24 wherein the surface includes the original surface and removing material includes removing at least a portion of the original surface to form a new surface, so that (a) the new surface has fewer protrusions than the original surface, (b) an effective radius of one or more protrusions on the new surface is increased over the one or more protrusions on the original surface, or (c) both (a) and (b).

27. The method of claim 24 wherein removing material includes removing material from the surface using an ion milling process.

28. The method of claim 24 wherein removing material includes removing material from the surface using an ion milling process to change the shape of the specimen.

29. The method of claim 24 wherein removing material includes removing material from the surface using a plasma.

30. The method of claim 24 wherein removing material includes removing material from the surface using a chemical etching process.

31. The method of claim 24 wherein removing material includes removing material from the surface using photonic energy.

32. A method for treating an atom probe specimen, comprising:
providing an atom probe specimen;
sensing at least one parameter associated with a shape of the specimen;
removing material from the surface of the specimen using an ion sputtering process; and
using a computing device to automatically control a voltage used in the ion sputtering process based on the at least one parameter.

33. The method of claim 32 wherein removing material includes removing at least a portion of a contaminant carried on the atom probe component.

34. The method of claim 32 wherein the surface includes the original surface and removing material includes removing at least a portion of the original surface to form a new surface, so that (a) the new surface has fewer protrusions than the original surface, (b) an effective radius of one or more protrusions on the new surface is increased over the one or more protrusions on the original surface, or (c) both (a) and (b).

35. The method of claim 32 wherein removing material includes removing material from the surface to change the shape of the specimen.

36. The method of claim 32 wherein sensing at least one parameter associated with the shape of the specimen includes sensing at least one of a tip radius of the specimen, a tip position of the specimen, and a field ion image quality.

37. The method of claim 32, further comprising sending data corresponding to the at least one parameter to the computing device.

38. The method of claim 32 wherein the method further comprises automatically terminating the ion sputtering process based on the at least one parameter.

39. A method for treating an atom probe component, comprising:
providing an atom probe component having a surface; and
introducing photonic energy proximate to the surface of the atom probe component to at least one of:
(a) remove material from the surface;
(b) make the surface smoother; and
(c) alter the microstructure of the surface.

40. The method of claim 39 wherein introducing photonic energy proximate to the surface of the atom probe component to remove material includes introducing photonic energy proximate to the surface of the atom probe component to remove at least a portion of a contaminant carried on the atom probe component.

41. The method of claim 39 wherein the surface includes the original surface and introducing photonic energy proximate to the surface of the atom probe component to remove material includes introducing photonic energy proximate to the surface of the atom probe component to remove at least a portion of the original surface to form a new surface, so that (a) the new surface has fewer protrusions than the original surface, (b) an effective radius of one or more protrusions on the new surface is increased over the one or more protrusions on the original surface, or (c) a and b.

42. The method of claim 39 wherein introducing photonic energy includes introducing photonic energy proximate to the surface to anneal the surface.

43. The method of claim 39 wherein introducing photonic energy includes introducing photonic energy proximate to the surface to melt the surface.

44. The method of claim 39 wherein altering the microstructure of the surface includes altering the microstructure of the surface to affect the work function associated with the surface.

45. The method of claim 39 wherein the atom probe component includes a specimen and wherein the method further comprises coating a portion of the specimen prior to introducing the photonic energy, wherein the coating is configured to absorb photonic energy.

46. The method of claim 39 wherein the atom probe component includes a specimen and wherein the method further comprises coating a portion of the specimen prior to introducing the photonic energy, wherein the coating is configured to reflect photonic energy.

47. The method of claim 39 wherein introducing photonic energy includes introducing photonic energy proximate to the atom probe component while the atom probe component is located in a portion of an atom probe device.

48. The method of claim 39 wherein introducing photonic energy includes introducing photonic energy proximate to the atom probe component while the atom probe component is located in a chamber that is couplable to an atom probe device.

49. A method for treating an atom probe component, comprising:
providing an atom probe component having a surface;
heating at least a portion of the surface to a high temperature; and
cooling a portion of the surface to anneal the at least a portion of the surface.

50. The method of claim 49 wherein annealing the at least a portion of the surface includes changing the microstructure of the at least a potion of the surface.

51. The method of claim 49 wherein cooling a portion of the surface includes cooling a portion of the surface in a portion of an atom probe device.

52. The method of claim 49 wherein cooling a portion of the surface includes cooling a portion of the surface in a chamber couplable to an atom probe device.

53. A method for treating an atom probe component, comprising:
providing an atom probe component having a surface; and
coating at least a portion of the surface with a material to at least one of:
(a) increase an effective radius of a protrusion;
(b) change the work function associated with the surface; and
(c) protect the surface from contamination.

54. The method of claim 53 wherein coating at least a portion of the surface includes at least one of electroplating process, a vapor deposition process, a plasma deposition process, a chemical vapor deposition process, a physical vapor deposition process, an electron beam deposition process, and a molecular beam epitaxy process.

55. The method of claim 53 wherein the material includes at least one of platinum, copper, and tungsten.

56. The method of claim 53 wherein coating includes coating the at least a portion of the surface while the surface is located in a potion of an atom probe device.

57. The method of claim 53 wherein coating includes coating the at least a portion of the surface while the surface is located in a chamber that is couplable to an atom probe device.

58. A method for treating an atom probe component, comprising:
positioning an atom probe component in an atom probe device; and
cooling at least a portion of the atom probe component to at least one of
(a) reduce a potential for field emissions, (b) reduce a potential for thermionic emission, and (c) reduce or slow a migration of contaminants within the atom probe device.

59. The method of claim 58 wherein cooling at least a portion of the atom probe component includes cooling a surface of the atom probe component below 100 Kelvin.

60. The method of claim 58 wherein cooling at least a portion of the atom probe component includes cooling at least a portion of the atom probe component during the analysis of a specimen.

61. The method of claim 58 wherein cooling at least a potion of the atom probe component includes cooling a first portion of a specimen, and wherein the method further comprises applying photonic energy to a second portion of the specimen.
